(19) United States
(12) Patent Application Publication
(10) Pub. No.: US 2003/0140087 A1
(43) Pub. Date: Jul. 24, 2003

(54) Systems and methods for negotiated resource utilization

(76) Inventors: Patrick Lincoln, Menlo Park, CA (US); Steven Dawson, Menlo Park, CA (US); David Stringer-Calvert, Menlo Park, CA (US)

Correspondence Address: Robert D Fish, Rutan & Tucker, Suite1400, 611 Anton Boulevard, Costa Mesa, CA, 92626, US

(21) Appl. No.: 10/089,393

(22) PCT Filed: Dec. 6, 2000
(86) PCT No.: PCT/US00/42673

(51) Int. Cl. G06F 15/16

(52) U.S. Cl. 709/201

(57) ABSTRACT

A resource (35) is recruited by a negotiation between two independent computers (10, 30). The computers (10, 30) are preferably at a significant distance from one another, and likely not part of the same local area network. The negotiation may be based on any condition or combination of conditions, including monetary or other compensation, a subject matter to which the resource (35) will be applied, a percent of avaibility of the resource (35) at the providing computer (30). The negotiation may also be based upon value, a recent value, a reliability value, a type of work value, or a compensation value. The negotiation may be facilitated by one of the computers (10, 30) listing either a need or an available resource (35) on a directory (22).

This application claims the benefit of U.S. provisional application No. 60/247,184 incorporated herein by reference in its entirety.

### FIELD OF THE INVENTION

The field of the invention is resource load balancing.

### BACKGROUND OF THE INVENTION

With the increasing number of users on the Internet comes the increasing probability that a single server will become inundated with requests for aresource. The result is often slow response times, large queues, and even system failure, despite the probable availability of alternate servers that could aid the primary server by off loading some of its tasks. This creates a problem of both resource over-utilization and resource under-utilization, both of which result in negative financial impact.

To alleviate these issues, an art known as ‘load balancing’ has been developed. Local load balancing systems are known, mostly based on hardware switches that route resource requests to one of a plurality of mirrored (i.e. containing identical content/resources) servers, giving the external appearance of a single, high-powered server. Global server load balancing systems have also recently emerged that attempt to distribute the traffic directed to any given server to a plurality of servers, whichare geographically distributed. See, for example, the approaches of Akamai (www.akamai.com) and Digital Island (www.digisle.net) for the distribution of web traffic.

As an alternative motivating example, consider a large data processing operation that has computing facilities in numerous locations throughout the world. If one location is overwhelmed, a systems administrator (whether human or machine) may choose to route additional operations to other locations. Similarly, it may be advantageous to employ several computers in a parallel processing mode to accomplish a single task. Even though several computers may be utilizing resources on other computers, there is never any negotiation among the several computers as to what tasks each one will take, and under what terms. If a computer is instructed to perform a given task, it takes on that task. The computer cannot refuse the work because the subject matter is undesirable for some reason, or the compensation is not sufficient.

All previously known load balancing systems and methods operate on a master-slave configuration. That scenario may work well for systems that are all owned or operated by the same company, or at least under the umbrella of a single company or other “master”, but doesn't work well at all for computers owned by independent operators. Yet there are many millions of independent computers throughout the world that are incredibly under-utilized, usually with under 20% utilization, and often with utilization of less than 5% or even 1%. While such users may at times make their computers available for such projects as the Search for Extraterrestrial Intelligence (SETI—see www.seti.org for details of their distributed processing utilizing screen savers), those computers, and their associated processing, storage, and other resources, will likely never be made available to others unless there are some sort of systems and methods in place by which the use of those resources can be automatically negotiated.

Consequently, there is a need in the art for systems where one computer can automatically recruit resources controlled by another, independent, computer through a negotiation between the computers.

The present invention provides systems and methods in which a resource is recruited by a negotiation between two independent computers. The computers are preferably at a significant distance from one another, and likely not part of the same local area network (LAN). Interaction of more than two computers is also contemplated, such that a single computer may negotiate resource usage with more than one other computer, and computers could act as consolidators/brokers to combine and offer for usage the combination of resources from multiple other computers. Contemplated resources are very wide-ranging, and include one or more processors, printers, storage devices, and communication channels.

The negotiation may be based on any condition or combination of conditions, including for example, a monetary or other compensation, a subject matter to which the resource will be applied, a percent of availability of the resource at the providing computer, and so forth. The negotiation may also be based upon one or more items of ratings information. Particularly contemplated ratings information may include data regarding a previous usage of the resource, including, for example, a satisfaction value, a promptness value, a recency value, a reliability value, a type of work value, or a compensation value.

The negotiation may be facilitated by one of the computers listing either a need or an available resource on a directory. To that end the directory may advantageously include a plurality of resource descriptions, at least one condition for use of each of the plurality of resource descriptions, and at least one item of ratings information for each of the plurality of resource descriptions.

### SUMMARY OF THE INVENTION

The present invention provides systems and methods in which a resource is recruited by a negotiation between two independent computers.

The computers are preferably at a significant distance from one another, and likely not part of the same local area network (LAN). Interaction of more than two computers is also contemplated, such that a single computer may negotiate resource usage with more than one other computer, and computers could act as consolidators to combine and offer for usage resources from multiple other computers.

Contemplated resources are very wide-ranging, and include one or more processors, printers, storage devices, and communication channels.

The negotiation may be based on any condition or combination of conditions, including for example, a monetary or other compensation, a subject matter to which the resource will be applied, a percent of availability of the resource at the providing computer, and so forth. The negotiation may also be based upon one or more items of ratings information. Particularly contemplated ratings information may include data regarding a previous usage of the resource, including, for example, a satisfaction value, a promptness value, a recency value, a reliability value, a type of work value, or a compensation value.

The negotiation may be facilitated by one of the computers listing either a need or an available resource on a directory. To that end the directory may advantageously include a plurality of resource descriptions, at least one condition for use of each of the plurality of resource descriptions, and at least one item of ratings information for each of the plurality of resource descriptions.

Various objects, features, aspects, and advantages of the present invention will become more apparent from the following detailed description that describes a preferred embodiment of the invention, along with the accompanying drawings in which like numerals represent like components.

### BRIEF DESCRIPTION OF THE DRAWING

FIG. 1 is a schematic of a system by which a requesting computer negotiates use of a resource controlled by a providing computer.

FIG. 2 is a table representation of data in a resource directory.

### DETAILED DESCRIPTION

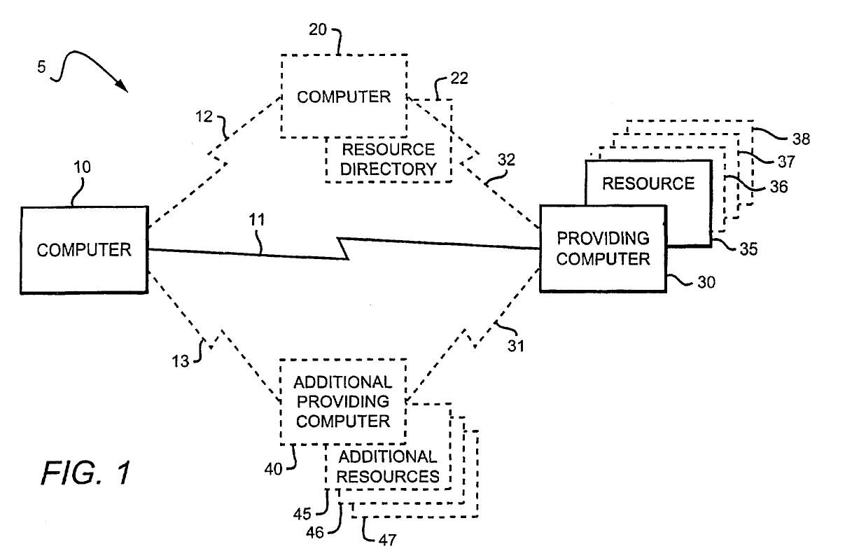

In FIG. 1, a system 5 generally comprises a requesting computer 10 communicating with a providing computer 30 to obtain access to a resource 35. Optionally (a) a directory hosting computer 30 may host a resource directory 22, (b) the providing computer 30 may provide access to other resources 36, 37, 38, and (c) an additional providing computer 40 may provide access to additional resources 45, 46, 47. Communication paths 11, 12, 13, 31, 32 provide one or two way connectivity among the various elements as shown.

Nature of the Computers

Requesting computer 10, and indeed all of the various computers described herein, may be any sort of computing device or system. Thus, computer 10 may be a supercomputer or other massively parallel device, a mainframe, minicomputer, desktop, laptop, personal digital assistant (PDA), or other microcomputer, as well as specialty devices such as cell phones, and a kitchen toaster or other appliance operatings computer. Computers 10, 20, 30, 40 may thus each also comprise a network of LANs or wide area networks (WANs). An especially preferred requesting computer 10 includes a central processing unit (CPU) of a multi CPU processing farm, with each CPU performing at a speed of at least 1 gigahertz. The system 5 is thought to be especially useful where computers 10, 20, 30, 40 are geographically separated from one another by a relatively large distance with respect to the reach of Ethernet technology, such as at least 1 km. Still more preferably distances separatings two or more of the computers 10, 20, 30, 40 are at least 5 km, at least 100 km, and at least 1000 km.

It is important to appreciate that at least the computers 10, 30, 40 are independent from one another in that none of them have a dedicated master-slave relationship over any of the others. Computers 10, 30, 40, may, for example, be owned or operated by separate companies or other entities. This independence allows them to negotiate freely among themselves, on the basis of time, compensation, subject matter, or any other condition or combination of conditions.

Nature of the Resources

In FIG. 1 the resources are depicted as resources 35, 36, 37, and 38. Any or all of these can be any combination of storage devices, processors, communication pipelines, printers, or any other computer controlled resources. Moreover, there may be fewer or greater than four resources controlled by provider 30, and some or all of these resources may be shared with yet other computers (not shown) or devices. Optional computer 40 has additional resources 45, 46, and 47 that can be accessed directly by negotiation between requesting computer 10 and additional providing computer 40, or indirectly by negotiation between requesting computer 10 and providing computer 30. Paths 13 and 32 may be used for these purposes, respectively. As is standard practice in other patent applications, computer 40, and resources 36, 37, 38, 45, 46, and 47 are all depicted in phantom to illustrate their optional nature.

Recruitment Message

The requesting computer 10 may advantageously monitor itself with respect to efficiency, backlog, or other operatings parameter or parameters. Such monitoring may be historical, concurrent, or even proactive, i.e., planning for future bottlenecks depending upon anticipated workload requirements. When the requesting computer 10 detects a condition of over utilization, inefficiency, or some other undesirable situation involving at least one of the parameters, it generates a recruitment message (not shown) that travels along communication path 12 to the resource computer 30.

In one contemplated embodiment, the requesting computer 10 multicasts the recruitment message for assistance to a plurality of computers until it is able to get assistance. In an alternative embodiment, the requesting computer 10 posts its requirement on some sort of bulletin board or other directory, as for example the directory 22 operated by the directory hosting computer 20.

The recruitment message preferably includes information sufficient for a potential providing computer to determine if a match is realistic. For example, if the requesting computer 10 is willing to pay only a much smaller amount for unit of resource than the offering computer is willing to accept, then there may be no need for negotiations. Similarly, if a potential providing computer does not have the resource needed, or can gain access to such resource at a reasonably time and cost, then there may be no need for negotiations. Sufficient information presently contemplated in at least some embodiments includes a priority for the task, the type of resource needed, the type of task, and a deadline for completion of the task.

It should be appreciated that where the recruitment message includes the type of task, a further benefit may be derived by delegating certain tasks to relatively slow processors. Some tasks do not require a high speed CPU to perform them, and therefore they may be delegated to one or more relatively slow processors without any significantly undesirable effects. This may reduce obsolescence of an enormous number of machines.

It should also be appreciated that the providing computer 20 may advantageously monitors itself in a similar manner to the requesting computer 10. If it detects a condition of under utilization for the resource, it may send out a message identifying the resources available, and the pricing or other conditions under which that resource may be utilized.

Communication Paths

The path 12 may be determined by any combination of direct addressing, active packet routing, narrow cast, and broadcast. The resource computer 30 may be selected by any suitable method, including an historical experience of the requesting computer 10 in utilizing a resource of the providing computer 30. Alternatively or additionally, the requesting computer 10 may take advantage of the historical experience of some other computer (not shown) in utilizing a resource of the providing computer 30. One contemplated embodiment of that scenario may involve posting of information relating to the historical experience on a directory such as directory 22. In yet another alternative embodiment, the resource computer 30 may be selected by the resource computer 30 sending a response (not shown) to the recruitment message.

The various communication paths 11, 12, 13, 31, 32 may be embodied in any suitable manner. Very likely one or more of such paths can take place on a public, packet switched network such as the Internet, and in such instances the paths would likely not be dedicated. On the other hand, all suitable embodiments are contemplated. It is contemplated, for example, that one or more of the paths 11, 12, 13, 31, 32 may be carried on a LAN or Wide Area Network other than the Internet. From another perspective, it is contemplated that one or more of the paths 11, 12, 13, 31, 32 may take place using hard wired telephone lines, fiber optics or other cabling, or some sort of local or global wireless transmission.

It is important to note that communication paths 11, 12, 13, 31, 32 need not be utilized for transfer of programs, data, or results. The various computers 10, 30, 40 may well utilize other paths (not shown) instead of, or in addition to the paths defined in FIG. 1.

Negotiation

The requesting computer 10 and the providing computer 30 negotiate at least one condition under which the providing computer 30 provides a resource 35 to the requesting computer. As used herein, the term “negotiate” means as a “bargained for” exchange. Consequently, no one party to the negotiation completely controls the terms. Also as used herein, the term “providing the resource” does not necessarily mean that the entire resource is turned over to the requesting computer 10, and indeed it is more likely that only a portion of the resource 35 will be made available to the requesting computer 10. Thus, if the resource 35 is a mass storage device such as a hard disk or collection of hard disks such as may be found in an EMC™ mass storage system, it is very likely that only a portion of the hard disk or mass storage system will be utilized by the requesting computer 10.

Although the negotiation can occur in any suitable manner, it is preferred that the negotiation occur in a completely automated manner, i.e. without direct human intervention. Presumably this means an exchange of messages between the requesting computer 10 and the providing computer 30. It is, however, also contemplated that negotiation can be conducted by, or at least assisted by, some sort of human or machine agent (not shown).

The requesting computer 10 and the providing computer 30 preferably negotiate based upon established negotiating algorithms, the conditions negotiated include the amount of compensation, the subject matter of the task, and the ability to perform the work.

Often, the result of the negotiation is formation of an “enclave” to perform a defined task that is to be completed by a deadline. Alternatively or additionally, the negotiation may result in performance of relatively undefined tasks, which may continue for days, weeks, or even longer periods of time. It is appreciated that formation and maintenance of the enclave may well involve many issues besides those discussed herein, including security considerations, trust relationships, adding and deleting members of the enclave, work distribution, and so forth.

Directory

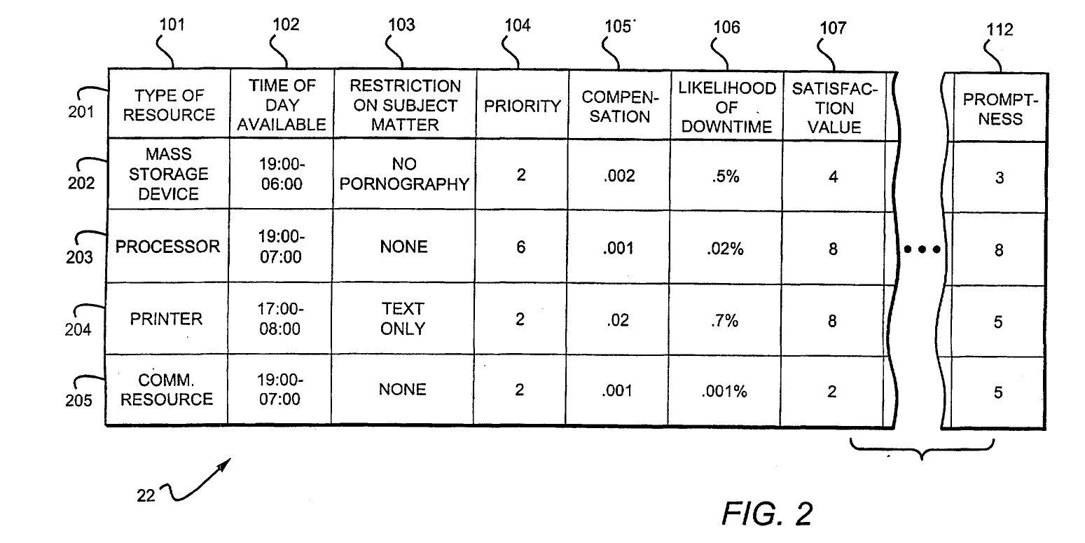

The system 5 optionally includes a directory hosting computer 20 that hosts a directory 22. In this case the directory 22 is designed to maintain a list of available resources, including many conditions. A more detailed explanation is set forth below with respect to FIG. 2. Directory hosting computer 20 could additionally or alternatively include a list of requests.

One aspect of the directory 22 is that it may include peer ratings resulting from prior usages of the resources. Peer ratings involves a subsystem where computers maintain historical statistics about other computers they have received assistance from. Contemplated statistics comprise an overall satisfaction value, a type of task, a reliability ratings, and a promptness ratings. One purpose of such a peer ratings system would be to provide a base line that the requesting computer 10 can use in its negotiation with the provider computer 30. If the ratings of the providing computer 20 with respect to resource 35 is relatively poor, the requesting computer 10 may well negotiate more favorable terms. Thus, the rate (in money or otherwise) that the requesting computer 10 may pay the providing computer may at least partially be based upon the peer ratings provided by the directory hosting computer 30.

Methods

FIG. 1 can be understood in method terms. In a broad interpretation, FIG. 1 depicts a method of recruiting a resource 35, comprising: establishing a communications link 12 between a requesting computer 10 and a providing computer 30 that is not controlled by the requesting computer 10; and the requesting computer 10 and the providing computer 30 negotiating a condition under which the providing computer 30 provides the resource 35 to the requesting computer 10.

The requesting computer is preferably located at a distance of at least 1 kilometer from the providing computer. If the requesting computer 10 and providing computer 30 are members of local area networks (not shown), they are preferably not members of the same LAN.

The step of negotiating preferably comprises negotiating a compensation rate for the use of the resource, which may be monetary, quid-pro-quo, or may involve some other compensation scheme. Another negotiated condition may include a subject matter to which the resource will be applied. For example, an individual computer owner may be willing to allow his computer to be used for processing financial information, but not for serving pornography. Another individual may be willing to have his computer used for any subject matter, but set different costs depending on the subject matter involved. Yet another negotiated condition may be a percent of availability of the resource at the providing computer. A computer owner/operator may decide to allow others to used 100% of his computer resources after working hours, but only 20% during working hours.

It is especially contemplated that provider computers may act as agents to secure and allocate the resources of other computers. In FIG. 1, providing computer 30 may recruit any or all of resources 45, 46, 47 controlled by additional providing computer 40. Although not shown in FIG. 1, this practice may be extended to one or more other computers and resources, each of which may in turn act as consolidators to combine and offer for usage resources from still other other computers.

With respect to the directory 22, it is contemplated that the requesting computer 10 may advantageously obtain an item of ratings and/or conditions information about the providing computer and its resources from a directory hosting computer; and the requesting computer 10 then executes a program code that negotiates an extent to which the requesting computer 10 interacts with the providing computer 20 based at least in part upon the obtained item of ratings and/or conditions information. The item of ratings information in the directory 22 may advantageously relate to a job previously executed by the providing computer 20 with respect to at least one of a satisfaction value, a promptness value, a recency value, a reliability value, a type of work value, and a compensation value. The conditions information may advantageously relate to the type of available resources, time of day at which the resources are available, other limitations including restrictions on subject matter and priority that a task will be allotted, the compensation demanded, the likelihood of downtime, and so forth.

In FIG. 2, directory 22 comprises a table of ratings information that typically resides on the directory hosting computer 20. Although the directory 22 is depicted here as a flat table, it is likely that the actual underlying structure of the directory 22 will be more complicated. The directory may advantageously be searched and sorted by users extrinsic to the directory hosting computer 20.

The order and indeed to exact content of the various columns is quite variable. In this instance column 101 contains the type of available resource, column 102 contains the time of day at which the resources are available, column 103 contains a restriction on subject matter, column 104 contains a priority that a task will be allotted, column 105 contains the compensation demanded, column 106 contains the likelihood of downtime, column 107 contains an aggregate satisfaction value, columns 108-111 (not shown) contain recency values, reliability values, type of work values, and IP address of the providing computers, respectively, and column 112 contains promptness values. Other contemplated tables could readily have a greater or lesser number of columns.

The various rows depict information for specific resources. Row 201 is merely a header identification row. Row 202 contains information relating to a mass storage device, row 203 contains information relating to a processor, row 204 contains information relating to a printer, and row 205 contains information relating to a communication resource. The table of FIG. 2 is, of course, truncated to show just a few of the available resources. A practical embodiment may well have hundreds, thousands, or even millions of resources.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A method of recruiting a resource, comprising:
establishing a communications link between a requesting computer and a providing computer that is not controlled by the requesting computer; and
the requesting computer and the providing computer negotiating a condition under which the providing computer provides the resource to the requesting computer.

2. The method of claim 1 wherein the requesting computer is located at a distance of at least 1 kilometer from the providing computer.

3. The method of claim 1 wherein the requesting computer and the providing computer are not both members of a single local area network.

4. The method of claim 1 wherein the step of negotiating comprises negotiating a compensation rate for the use of the resource.

5. The method of claim 1 wherein the step of negotiating comprises negotiating a subject matter to which the resource will be applied.

6. The method of claim 1 wherein the step of negotiating comprises negotiating a percent of availability of the resource at the providing computer.

7. The method of claim 1 wherein the step of negotiating comprises negotiating another condition under which an additional resource computer provides another resource to the requesting computer.

8. The method of claim 6 wherein an additional resource computer is located is located at a distance of at least 1 kilometer from the requesting computer.

9. The method of claim 1 further comprising:
the requesting computer obtaining an item of ratings information about the providing computer from a directory hosting computer; and
the requesting computer executing a first program code that determines an extent to which the requesting computer interacts with the providing computer based at least in part upon the obtained item of ratings information.

10. The method of claim 9 wherein the item of ratings information relates to a job previously executed by the providing computer with respect to at least one of a satisfaction value, a promptness value, a recency value, a reliability value, a type of work value, and a compensation value.

11. The method of claim 9 wherein the step of negotiating includes the requesting computer using the item of ratings information obtained from the directory hosting computer to negotiate with the providing computer.

12. The method of claim 1 further comprising the providing computer listing the resource on a directory of available resources.

13. The method of claim 12 further comprising the providing computer listing the condition on the directory of available resources.

14. The method of claim 12 further comprising a hosting computer hosting the directory, and associating a ratings with the providing computer.

15. The method of claim 12 further comprising the providing computer additionally listing an item of ratings information on the directory.

16. The method of claim 1 wherein the step of negotiating occurs automatically without any direct human intervention.

17. The method of claim 1 further comprising the requesting computer broadcasting a recruitment message.

18. A directory of computer controlled resources, comprising:
a plurality of resource descriptions;
at least one condition for use of each of the plurality of resource descriptions; and
at least one item of ratings information for each of the plurality of resource descriptions, wherein the at least one item of ratings information is used by a requesting computer to negotiate with a providing computer.

19. The directory of claim 18, wherein the condition relates to at least one resource availability factor selected from: available time, subject matter restriction, task priority, compensation, and likelihood of downtime.

20. The directory of claim 18 wherein the condition comprises an authorization for the requesting computer to report to a directory hosting computer another item of ratings information regarding an interaction between the requesting computer and the providing computer.

21. The directory of claim 18, wherein the item of ratings information includes at least one of a satisfaction value, a promptness value, a recency value, a reliability value, a type of work value, and a compensation value.
